(19) United States
(12) Patent Application Publication
(10) Pub. No.: US 2025/0088065 A1
(43) Pub. Date: Mar. 13, 2025

(54) SCANNING DRIVE MOTOR AND PRE-TIGHTENING METHOD, ROTATING MIRROR, LIDAR, AND MOBILE DEVICE

(71) Applicant: Suteng Innobation Technology Co. Ltd., Shenzhen (CN)

(72) Inventors: Youxue Lei, Shenzhen (CN); Congcong Zhu, Shenzhen (CN); Jiadi Wang, Shenzhen (CN); Bihua Zhu, Shenzhen (CN)

(73) Assignee: Suteng Innobation Technology Co. Ltd., Shenzhen (CN)

(21) Appl. No.: 18/793,125

(22) Filed: Aug. 2, 2024

(30) Foreign Application Priority Data
Sep. 7, 2023 (CN) 202311160202.8

(51) Int. Cl. H02K 5/173; G01D 5/347; G01S 7/481; H02K 7/08; H02K 33/16

(52) U.S. Cl. CPC H02K 5/1735; G01D 5/34707; G01S 7/4817; H02K 7/085; H02K 33/16

(57) ABSTRACT

This application discloses an embodiment of a scanning drive motor and pre-tightening method, rotating mirror, LiDAR, and mobile device. The scanning drive motor includes an integrated bearing structure, a mover assembly, and a stator assembly. The integrated bearing structure comprises a first bearing, a second bearing, and a rotating shaft. The first bearing includes a first inner ring and a first outer ring, and the second bearing includes a second inner ring and a second outer ring. The first bearing and the second bearing are both sleeved on the rotating shaft, and the first inner ring and the second inner ring are both connected to the rotating shaft. The mover assembly includes a mover. The stator assembly includes a stator and a stator base. The stator is connected to the stator base, which forms a bearing chamber. The scanning drive motor is more convenient to assemble.

### CROSS-REFERENCE TO RELATED APPLICATION

The present application claims the benefit of priority to Chinese Patent Application No. 202311160202.8, filed on Sep. 7, 2023, which is hereby incorporated by reference in its entirety.

### TECHNICAL FIELD

This application relates to the technical field of laser detection equipment, particularly to a scanning drive motor and pre-tightening method, rotating mirror, LiDAR, and mobile device.

### BACKGROUND

Light Detection and Ranging (LiDAR) is a radar system that uses laser beams to detect the position, speed, and other characteristics of a target. Its working principle is to first emit a detection laser beam towards the target, then compare the received signal reflected back from the target with the emitted signal. After appropriate processing, information about the target can be obtained, such as distance, direction, altitude, speed, attitude, and even shape.

To improve the detection field of view angle of the LiDAR, it usually includes two components that can rotate relative to each other, such as a mover assembly and a stator assembly. The mover assembly and the stator assembly are connected through structures like a rotating shaft and bearings to improve the smoothness of their relative motion. However, during assembly, related technology usually involves assembling the rotating shaft, bearings, etc., separately with the mover assembly and the stator assembly, which is cumbersome.

### SUMMARY

In a first aspect, embodiments of this application provides a scanning drive motor, including an integrated bearing structure, a mover assembly, and a stator assembly. The integrated bearing structure includes a first bearing, a second bearing, and a rotating shaft. The first bearing includes a first inner ring and a first outer ring, and the second bearing includes a second inner ring and a second outer ring. The first bearing and the second bearing are both sleeved on the rotating shaft, and the first inner ring and the second inner ring are both connected to the rotating shaft. The mover assembly includes a mover. The stator assembly includes a stator and a stator base. The stator is connected to the stator base, which forms a bearing chamber. The first bearing, the second bearing, and at least part of the rotating shaft are located in the bearing chamber. At least one of the first outer ring and the second outer ring is connected to the stator base. The rotating shaft is connected to the mover assembly, and the mover can rotate around the central axis of the rotating shaft relative to the stator.

In a second aspect, embodiments of this application provides a rotating mirror, including a scanning part and the above-mentioned scanning drive motor. The scanning part has multiple reflective surfaces and is connected to the mover assembly. The multiple reflective surfaces are arranged around the central axis of the rotating shaft.

In a third aspect, embodiments of this application provides a LiDAR, including a laser transceiving assembly and the above-mentioned rotating mirror. The laser transceiving assembly includes an emitter and a receiver. The emitter is used to emit a detection light signal towards a target object in a target area, and the receiver is used to receive an echo light signal, which is formed by at least part of the detection light signal being reflected by the target object. The rotating mirror is located downstream of the detection light signal emitted by the emitter and upstream of the echo light signal received by the receiver.

In a fourth aspect, embodiments of this application provides a LiDAR, including an integrated bearing structure, a mover assembly, a stator assembly, and a laser transceiving assembly. The integrated bearing structure includes a first bearing, a second bearing, and a rotating shaft. The first bearing includes a first inner ring and a first outer ring, and the second bearing includes a second inner ring and a second outer ring. The first bearing and the second bearing are both sleeved on the rotating shaft, and the first inner ring and the second inner ring are both connected to the rotating shaft. The mover assembly includes a mover. The stator assembly includes a stator and a stator base. The stator is connected to the stator base, which forms a bearing chamber. The first bearing, the second bearing, and at least part of the rotating shaft are located in the bearing chamber. At least one of the first outer ring and the second outer ring is connected to the stator base. The rotating shaft is connected to the mover assembly, and the mover can rotate around the central axis of the rotating shaft relative to the stator. The laser transceiving assembly is connected to the mover assembly.

In a fifth aspect, embodiments of this application provides a mobile device, including a main body and the above-mentioned LiDAR. The LiDAR is connected to the main body.

In a sixth aspect, embodiments of this application provides a pre-tightening method for the integrated bearing structure in the scanning drive motor, including:
sleeving the first bearing on the rotating shaft and connecting the first inner ring of the first bearing to the rotating shaft;
sleeving the pre-tightening member on the rotating shaft and abutting the pre-tightening member against the first outer ring of the first bearing;
sleeving the second bearing on the rotating shaft on the side of the pre-tightening member deviating from the first bearing, abutting the second outer ring of the second bearing against the pre-tightening member, and applying adhesive between the second inner ring of the second bearing and the rotating shaft, where the adhesive is not cured;
applying force to the first inner ring and the second inner ring, making them close to each other, and when the adhesive cures, the pre-tightening of the first bearing and the second bearing in the integrated bearing structure is implemented.

In a seventh aspect, embodiments of this application provides a pre-tightening method for the integrated bearing structure in the scanning drive motor, including:
sleeving the first bearing on the rotating shaft and connecting the first inner ring of the first bearing to the rotating shaft;
sleeving the second bearing on the rotating shaft and connecting the second inner ring of the second bearing to the rotating shaft, achieving the assembly of the integrated bearing structure;
placing the integrated bearing structure in the bearing chamber, applying adhesive between the first outer ring of the first bearing and the inner wall surface of the bearing chamber and/or between the second outer ring of the second bearing and the inner wall surface of the bearing chamber, where the adhesive is not cured;
applying force to the first outer ring and the second outer ring, making them close to each other, and when the adhesive cures, the pre-tightening of the first bearing and the second bearing is implemented.

In an embodiment, a pre-tightening method for the integrated bearing structure in the scanning drive motor is disclosed, comprising:
sleeving the first bearing on the rotating shaft, and connecting the first inner ring of the first bearing to the rotating shaft;
sleeving the second bearing on the rotating shaft, and connecting the second inner ring of the second bearing to the rotating shaft, to implement assembly of the integrated bearing structure;
placing the integrated bearing structure in the bearing chamber, wherein an adhesive is arranged between and/or the second outer ring of the second bearing and the inner wall surface of the bearing chamber, wherein the adhesive is not cured; and
applying a force to the first outer ring and the second outer ring, so that the first outer ring and the second outer ring are close to each other, and when the adhesive is cured, pre-tightening of the first bearing and the second bearing can be implemented.

In an embodiment, wherein before the placing the integrated bearing structure in the bearing chamber, the method further comprises: placing the stator base on a second jig, wherein a limiting projection of the second jig extends into the bearing chamber of the stator base, and a positioning surface of the second jig abuts against a mounting surface of the stator base, wherein the mounting surface is perpendicular to a central axis of the bearing chamber; and
after the placing the integrated bearing structure in the bearing chamber, the method further comprises: placing a part of the rotating shaft in a third limit hole of the second jig, and making a third abutting surface of the limiting projection abut against the first outer ring, wherein the positioning surface is perpendicular to a central axis of the third limit hole; and
wherein the applying a force to the first outer ring and the second outer ring, so that the first outer ring and the second outer ring are close to each other comprises: arranging a second weight on a side of the second bearing deviating from the first bearing, and making a fourth abutting surface of the second weight abut against the second outer ring, and arranging a part of the rotating shaft in a fourth limit hole of the second weight, wherein the third limit hole and the fourth limit hole extend along a vertical direction, and wherein a central axis of the fourth abutting surface is perpendicular to a central axis of the fourth limit hole.

The scanning drive motor and pre-tightening method, rotating mirror, LiDAR, and mobile device of this application make the assembly more convenient by designing the first bearing, the second bearing, and the rotating shaft as an integrated bearing structure, allowing the integrated bearing structure to be assembled together with the mover assembly and the stator assembly, compared to the related technology where two bearings, the rotating shaft, the mover assembly, and the stator assembly are assembled separately.

### BRIEF DESCRIPTION OF DRAWINGS

To clearly explain the technical solutions in the embodiments, the following drawings are briefly introduced.

FIG. 1 is a schematic structural view of the LiDAR provided in a first embodiment;

FIG. 2 is a schematic structural view of the scanning drive motor in the LiDAR shown in FIG. 1;

FIG. 3 is a schematic structural view of the integrated bearing structure in the LiDAR shown in FIG. 2;

FIG. 4 is a schematic structural view of the mobile device provided in an embodiment;

FIG. 5 is a schematic view of the pre-tightening process of the integrated bearing structure in the LiDAR shown in FIG. 2;

FIG. 6 is a flow chart of the pre-tightening process of the integrated bearing structure in the LiDAR shown in FIG. 2;

FIG. 7 is a schematic structural view of the LiDAR provided in an embodiment;

FIG. 8 is a schematic view of the pre-tightening process of the integrated bearing structure in the LiDAR shown in FIG. 7;

FIG. 9 is a flow chart of the pre-tightening process of the integrated bearing structure in the LiDAR shown in FIG. 7;

FIG. 10 is another flow chart of the pre-tightening process of the integrated bearing structure in the LiDAR shown in FIG. 7;

FIG. 11 is a schematic structural view of the LiDAR provided in an embodiment;

FIG. 12 is a schematic view of the pre-tightening process of the bearing in the LiDAR shown in FIG. 11;

FIG. 13 is a schematic structural view of the LiDAR provided in an embodiment.

### LIST OF REFERENCE NUMERALS

1. LiDAR; 2. Mobile device; 3. Main body;
100. Rotating mirror; 110. Scanning drive motor; 120. Scanning part;
130. Reflective surface; 200. Emitter; 300. Receiver; 400. Galvanometer;
10. Integrated bearing structure; 11. First bearing; 111. First inner ring;
112. First outer ring; 113. First rolling part; 114. First track;
12. Second bearing; 121. Second inner ring; 122. Second outer ring;
123. Second rolling part; 124. Second track;
13. Rotating shaft; 14. Pre-tightening member;
141. First mating surface; 142. Second mating surface;
20. Mover assembly; 21. Mover; 22. Housing;
221. Sixth abutting surface; 222. Side surface; 223. Seventh limit hole;
30. Stator assembly; 31. Stator; 32. Stator base;
321. Bearing chamber; 322. First inner wall surface; 323. Mounting surface;
50. Code disc; 51. Detection part; 60. Photoelectric switch;
70. First jig; 71. First abutting surface; 72. First limit hole;
80. First weight; 81. Second abutting surface; 82. Second limit hole;
90. Second jig; 91. Limiting projection; 911. Third abutting surface;
92. Positioning surface; 93. Third limit hole; 94. Second weight;
95. Fourth abutting surface; 96. Fourth limit hole; 97. Wave spring;
101. Third jig; 102. Fifth abutting surface; 103. Fifth limit hole;
104. Third weight; 105. Sixth limit hole; x. Central axis.

### DETAILED DESCRIPTION

To make the objectives, technical solutions, and advantages of this application clearer, the embodiments of this application will be further described in detail below in conjunction with the accompanying drawings.

In the following description, when referring to the drawings, the same numbers in different drawings represent the same or similar elements unless otherwise indicated. The embodiments described in the following exemplary embodiments do not represent all embodiments consistent with this application. Instead, they are merely some examples of devices and methods consistent with some aspects of this application, as detailed in the claims.

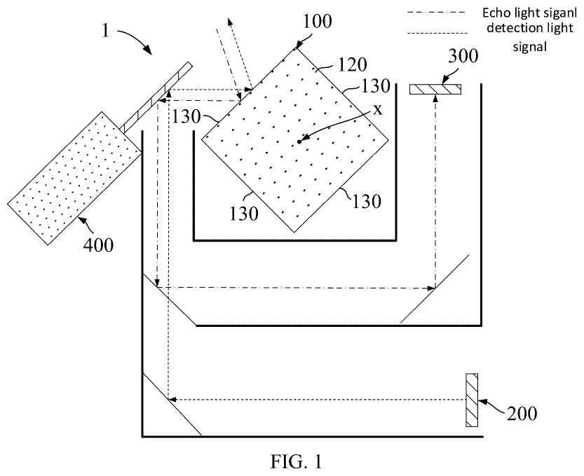

In a first aspect, referring to FIG. 1, embodiments of this application provides a LiDAR 1, which can be a solid-state LiDAR. The LiDAR 1 includes a rotating mirror 100 and a laser transceiving assembly.

The laser transceiving assembly includes an emitter 200 and a receiver 300, the emitter 200 is used to emit a detection light signal, the detection light signal is used to be emitted towards a target object in a target region, and the receiver 300 is used to receive an echo light signal, which is formed by at least part of the detection light signal being reflected by the target object. The rotating mirror 100 is located downstream of the detection light signal emitted by the emitter 200, and the rotating mirror 100 is located upstream of the echo light signal received by the receiver 300.

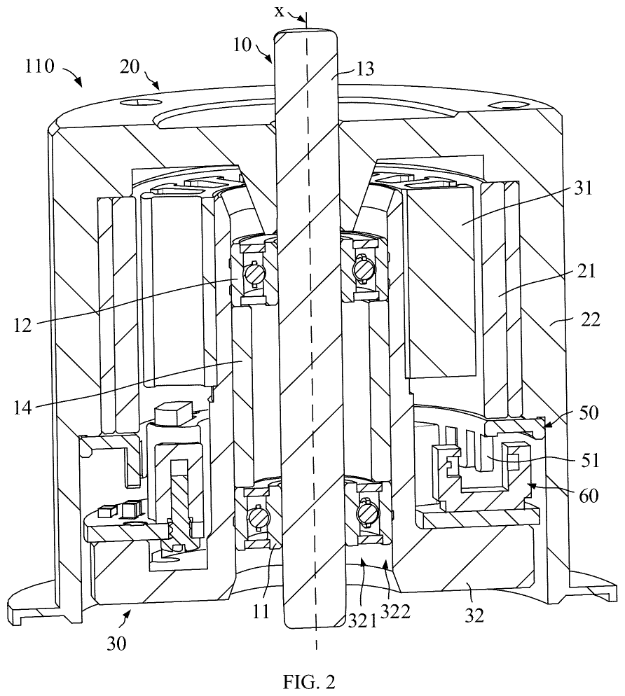

Referring to FIG. 1 and FIG. 2, the rotating mirror 100 includes a scanning drive motor 110 and a scanning part 120. The scanning part 120 has multiple reflective surfaces 130, and the multiple reflective surfaces 130 are arranged around the central axis x. The scanning drive motor 110 is used to drive the scanning part 120 to rotate around the central axis x, to change the emission field of view angle of the detection light signal emitted by the LiDAR 1 and the reception field of view angle of the echo light signal received by the LiDAR 1, thereby achieving multi-directional scanning of the LiDAR 1.

Referring to FIG. 2, the scanning drive motor 110 includes an integrated bearing structure 10, a mover assembly 20, and a stator assembly 30.

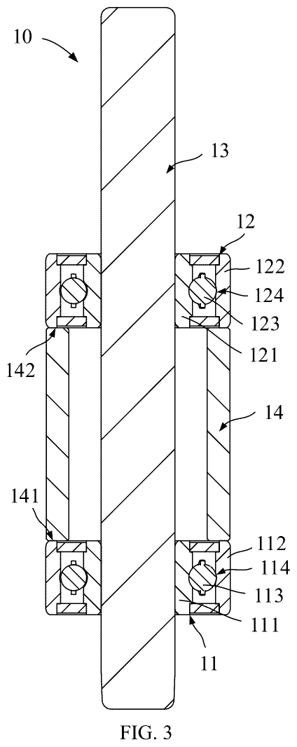

Referring to FIG. 2 and FIG. 3, the integrated bearing structure 10 includes a first bearing 11, a second bearing 12, and a rotating shaft 13. The first bearing 11 includes a first inner ring 111 and a first outer ring 112, and the second bearing 12 includes a second inner ring 121 and a second outer ring 122. The first bearing 11 and the second bearing 12 are both sleeved on the rotating shaft 13, and the first inner ring 111 and the second inner ring 121 are both connected to the rotating shaft 13. The central axis x can be the central axis of the rotating shaft 13.

In an embodiment, by designing the first bearing 11, the second bearing 12, and the rotating shaft 13 as an integrated bearing structure 10, during the assembly of the scanning drive motor 110, the integrated bearing structure 10 can be assembled together with the mover assembly 20 and the stator assembly 30, making the assembly more convenient compared to the related technology where two bearings, the rotating shaft, the mover assembly, and the stator assembly are assembled separately.

In an embodiment, the first bearing 11 includes multiple first rolling parts 113, and a first track 114 is formed between the first inner ring 111 and the first outer ring 112, with multiple first rolling parts 113 located in the first track 114. The first rolling parts 113 can be balls, etc. The second bearing 12 further includes multiple second rolling parts 123, and a second track 124 is formed between the second inner ring 121 and the second outer ring 122, with multiple second rolling parts 123 located in the second track 124. The second rolling parts 123 can be balls, etc.

The mover assembly 20 includes a mover 21. The stator assembly 30 includes a stator 31 and a stator base 32, the stator 31 is connected to the stator base 32, and the stator base 32 forms a bearing chamber 321. The first bearing 11, the second bearing 12, and at least part of the rotating shaft 13 are all located in the bearing chamber 321. At least one of the first outer ring 112 and the second outer ring 122 is connected to the stator base 32. The rotating shaft 13 is connected to the mover assembly 20, and the mover 21 can rotate around the central axis x of the rotating shaft 13 relative to the stator 31. The scanning part 120 is connected to the mover assembly 20. Optionally, the scanning part can also be integrated with the mover assembly.

In an embodiment, the mover 21 rotates around the central axis x of the rotating shaft 13 relative to the stator 31, allowing the mover assembly 20 to rotate around the central axis x of the rotating shaft 13 relative to the stator assembly 30, further allowing the scanning part 120 connected to the mover assembly 20 to rotate around the central axis x of the rotating shaft 13. By rotating around the central axis x of the rotating shaft 13, can change the angle of the reflective surface 130 of the scanning part 120, allowing the detection light signal to be emitted in different directions and the echo light signal to be received from different directions, achieving scanning detection within the preset field of view angle range of the LiDAR 1.

When the mover assembly 20 rotates relative to the stator assembly 30, the first inner ring 111 of the first bearing 11 will rotate relative to the first outer ring 112, and the second inner ring 121 of the second bearing 12 will rotate relative to the second outer ring 122. The rotational precision of the first inner ring 111 relative to the first outer ring 112, and the rotational precision of the second inner ring 121 relative to the second outer ring 122, will determine the rotational precision of the mover assembly 20 relative to the stator assembly 30, and further determine the detection precision of the LiDAR 1.

To eliminate the clearance of the first bearing 11 and the second bearing 12, improve the rotational precision of the first bearing 11 and the second bearing 12, and improve the detection precision of the LiDAR 1, referring to FIG. 2 and FIG. 3, the integrated bearing structure 10 further includes a pre-tightening member 14, sleeved on the rotating shaft 13, located between the first bearing 11 and the second bearing 12. The first inner ring 111 of the first bearing 11 and the second inner ring 121 of the second bearing 12 are both connected to the rotating shaft 13, and the first outer ring 112 of the first bearing 11 and the second outer ring 122 of the second bearing 12 are both connected to the pre-tightening member 14, to implement pre-tightening of the first bearing 11 and the second bearing 12.

The pre-tightening of the first bearing 11 can ensure that the movement trajectory of the first rolling part 113 is a ring perpendicular to the axial direction and not easily fluctuating along the axial direction, thereby improving the rotational precision of the first bearing 11, extending its service life, and reducing vibration noise during its use. The pre-tightening of the second bearing 12 can ensure that the movement trajectory of the second rolling part 123 is roughly a ring perpendicular to the axial direction and not easily fluctuating along the axial direction, thereby improving the rotational precision of the second bearing 12, extending its service life, and reducing vibration noise during its use.

When the integrated bearing structure 10 with pre-tightened first bearing 11 and second bearing 12 is applied to the scanning drive motor 110 or other equipment, it can be placed in the scanning drive motor 110 and connected, making the pre-tightening process more convenient compared to the related technology where two bearings are installed separately in the bearing seat and then pre-tightened. It avoids structural damage to the bearing seat caused by squeezing during pre-tightening, preventing bearing outer ring inclination, noise, and motor life impact.

During pre-tightening of the first bearing 11 and the second bearing 12, the first inner ring 111 of the first bearing 11 and the second inner ring 121 of the second bearing 12 can be fixedly connected to the rotating shaft 13, while the first outer ring 112 of the first bearing 11 and the second outer ring 122 of the second bearing 12 can respectively abut against the opposite ends of the pre-tightening member 14. The pre-tightening member 14's opposite ends provide opposite pre-tightening forces to the first outer ring 112 and the second outer ring 122, causing them to move apart and eliminate the clearance of the first bearing 11 and the second bearing 12. At least one of the first outer ring 112 and the second outer ring 122 can also be mechanically connected to the pre-tightening member 14, rather than just abutting against it.

The first inner ring 111 can be fixedly connected to the rotating shaft 13 by adhesive, interference fit, welding, etc. Similarly, the second inner ring 121 can also be fixedly connected to the rotating shaft 13 by adhesive, interference fit, welding, etc. In an embodiment, at least one of the first inner ring 111 and the second inner ring 121 is connected to the rotating shaft 13 by adhesive, allowing position adjustment of the first inner ring 111 and the second inner ring 121 during the pre-tightening process before the adhesive cures, and maintaining the pre-tightened state after the adhesive cures.

Furthermore, both the first inner ring 111 and the second inner ring 121 are connected to the rotating shaft 13 by adhesive. Adhesive connections can better ensure the rotational precision of the first bearing 11 and the second bearing 12 compared to interference fit connections.

Referring to FIG. 3, the pre-tightening member 14 has a first mating surface 141 that abuts the first outer ring 112 and a second mating surface 142 that abuts the second outer ring 122. The first mating surface 141 and the second mating surface 142 are oppositely arranged along the length direction of the rotating shaft 13, both around the rotating shaft 13, and parallel. The parallel arrangement of the first mating surface 141 and the second mating surface 142 ensures that the pre-tightening force applied by the pre-tightening member 14 to the first outer ring 112 and the second outer ring 122 is stable and not prone to deviation, enhancing the stability of the first bearing 11 and the second bearing 12 during operation and reducing noise. During production, the existing processing technology can achieve a high degree of parallelism between the first mating surface 141 and the second mating surface 142 of the pre-tightening member 14, meeting pre-tightening requirements.

The pre-tightening member 14 in an embodiment can be a rigid member, meaning the pre-tightening member 14 does not easily deform under a certain force, providing stable pre-tightening force to the first outer ring 112 and the second outer ring 122. The cross-sectional profile of the pre-tightening member 14 along the length direction of the rotating shaft 13 can remain unchanged, ensuring that the structural strength of each part of the pre-tightening member 14 is roughly the same.

Referring to FIG. 2, to facilitate the assembly of the integrated bearing structure 10 with the stator base 32, the bearing chamber 321 of the stator base 32 can have at least one port, allowing the integrated bearing structure 10 to be placed into the bearing chamber 321 from the port. The port diameter of the bearing chamber 321 can be set relatively large to facilitate the insertion of the integrated bearing structure 10.

In an embodiment, the bearing chamber 321 has two opposite ports, allowing the integrated bearing structure 10 to be placed into the bearing chamber 321 from either port.

The stator base 32 has a first inner wall surface 322 that participates in forming the bearing chamber 321. The first inner wall surface 322 is a cylindrical surface that extends along the length direction of the rotating shaft 13 and is arranged around the rotating shaft 13. The first bearing 11, the second bearing 12, and the pre-tightening member 14 can all be arranged corresponding to the first inner wall surface 322. By setting the first inner wall surface 322 as a cylindrical surface, the corresponding space can be directly formed by processes such as stamping, achieving higher coaxiality of the first inner wall surface 322 along the length direction of the rotating shaft 13 (e.g., coaxiality within φ0.01 mm), thereby enhancing the rotational precision of the first bearing 11 and the second bearing 12 arranged corresponding to the first inner wall surface 322, and improving the detection precision of the LiDAR 1.

In an embodiment, the mover 21 can rotate relative to the stator 31 by magnetic drive. For example, the mover 21 can include one of a coil and a permanent magnet, and the stator 31 can include the other of a coil and a permanent magnet. By periodically energizing the coil, the magnetic field around the coil can be changed, achieving the movement of the mover 21 relative to the stator 31.

In an embodiment, besides the mover 21, the mover assembly 20 can include a housing 22 connected to the mover 21, which can cover the stator assembly 30.

In an embodiment, the scanning part 120 and the housing 22 can be the same structure. In this case, the reflective surface 130 of the scanning part 120 can correspond to the outer side surface of the housing 22. Of course, the scanning part 120 and the housing 22 can also be different structures. In this case, the scanning part 120 can be generally located above the housing 22 and connected to the housing 22 and/or the rotating shaft 13, enabling rotation around the central axis x driven by the mover assembly 20.

Referring to FIG. 2, the scanning drive motor 110 includes a code disc 50 and a photoelectric switch 60. The code disc 50 is connected to one of the mover assembly 20 and the stator assembly 30, and the photoelectric switch 60 is connected to the other of the mover assembly 20 and the stator assembly 30. The code disc 50 includes multiple detection parts 51, which are arranged at circumferential intervals around the rotating shaft 13. When the mover 21 rotates around the central axis x of the rotating shaft 13 relative to the stator 31, the multiple detection parts 51 of the code disc 50 pass the photoelectric switch 60 in turn. The code disc 50 and the photoelectric switch 60 can measure the angular displacement of the mover assembly 20 relative to the stator assembly 30.

In an embodiment, the photoelectric switch 60 can include an emitting part and a receiving part arranged at intervals, and multiple detection parts 51 on the code disc 50 can sequentially pass between the emitting part and the receiving part of the photoelectric switch 60. When a detection part 51 is located between the emitting part and the receiving part, the light emitted by the emitting part cannot be received by the receiving part. When the gap between two adjacent detection parts 51 corresponds to the emitting part and the receiving part, the light emitted by the emitting part can be received by the receiving part as it is not blocked by the detection part 51. Accordingly, the photoelectric switch 60 can count the number of detection parts 51 on the code disc 50 that pass between the emitting part and the receiving part within a certain period, thereby determining the angle through which the code disc 50 has rotated, achieving angular displacement measurement. For example, if the angle between the centers of two adjacent detection parts 51 on the code disc 50 is 1°, and the photoelectric switch 60 counts that two detection parts 51 on the code disc 50 have passed between the emitting part and the receiving part within a unit time, then the code disc 50 has rotated an angle slightly greater than 1° and less than 3° within that unit time. By increasing the number of detection parts 51 on the code disc 50 and reducing the angle between adjacent detection parts 51, the detection accuracy of the photoelectric switch 60 can be improved.

The detection parts 51 on the code disc 50 can extend in a direction parallel to the central axis x of the rotating shaft 13 or in a direction perpendicular to the central axis x of the rotating shaft 13. The actual manufacturing can be flexibly adjusted.

The scanning drive motor 110 can include a circuit board, etc. The photoelectric switch 60 can be mounted on and electrically connected to the circuit board. In this embodiment, both the circuit board and the photoelectric switch 60 can be connected to the stator base 32, and the code disc 50 can be connected to the mover assembly 20.

In an embodiment, the LiDAR 1 can include a galvanometer 400. Along the transmission direction of the detection light, the galvanometer 400 can be located between the emitter 200 and the rotating mirror 100. Along the transmission direction of the echo light, the galvanometer 400 can be located between the rotating mirror 100 and the receiver 300. The galvanometer 400 can rotate around a direction perpendicular to the central axis x, combining with the rotating mirror 100 to enhance the scanning field of view angle of the LiDAR 1 in two perpendicular directions. The LiDAR 1 may also not include a galvanometer 400.

The technical solution of the integrated bearing structure in an embodiment is applicable to mechanical LiDAR. In an embodiment, the LiDAR is a mechanical LiDAR, it includes an integrated bearing structure, a mover assembly, a stator assembly, and a laser transceiving assembly. The integrated bearing structure includes a first bearing, a second bearing, and a rotating shaft. The first bearing includes a first inner ring and a first outer ring, and the second bearing includes a second inner ring and a second outer ring. The first bearing and the second bearing are both sleeved on the rotating shaft, and the first inner ring and the second inner ring are both connected to the rotating shaft. The mover assembly includes a mover. The stator assembly includes a stator and a stator base. The stator is connected to the stator base, which forms a bearing chamber. The first bearing, the second bearing, and at least part of the rotating shaft are located in the bearing chamber. At least one of the first outer ring and the second outer ring is connected to the stator base. The rotating shaft is connected to the mover assembly, and the mover can rotate around the central axis of the rotating shaft relative to the stator. The laser transceiving assembly is connected to the mover assembly, allowing the mover assembly to rotate around the central axis of the rotating shaft relative to the stator assembly, thereby rotating the laser transceiving assembly around the central axis of the rotating shaft, enhancing the detection field of view corresponding to the emitter and the receiver, and achieving multi-directional detection of the LiDAR.

In an embodiment, the LiDAR is a mechanical LiDAR, its integrated bearing structure, mover assembly, and stator assembly can use the same structure as the integrated bearing structure 10, mover assembly 20, and stator assembly 30 in the scanning drive motor 110 described above, without further description. If the LiDAR is a mechanical LiDAR, it can also include a code disc and a photoelectric switch, which can use the same structure as the code disc 50 and the photoelectric switch 60 in the scanning drive motor 110 described above.

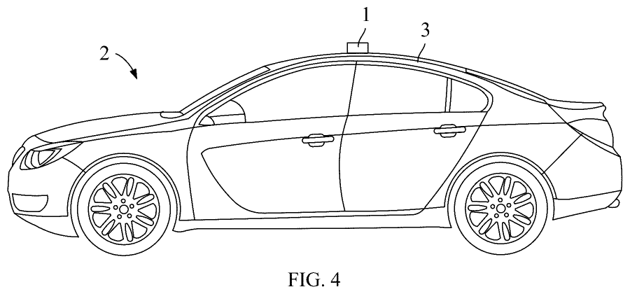

In a second aspect, referring to FIG. 4, embodiments of this application provides a mobile device 2, which includes a main body 3 and the above-mentioned LiDAR 1. The LiDAR 1 is connected to the main body 3. In some embodiments, the mobile device 2 is an automobile, and the main body 3 is the automobile body. The LiDAR 1 is mounted on the automobile body. In an embodiment, the mobile device 2 can be a device other than an automobile that is equipped with the LiDAR 1, such as a drone, robot, etc.

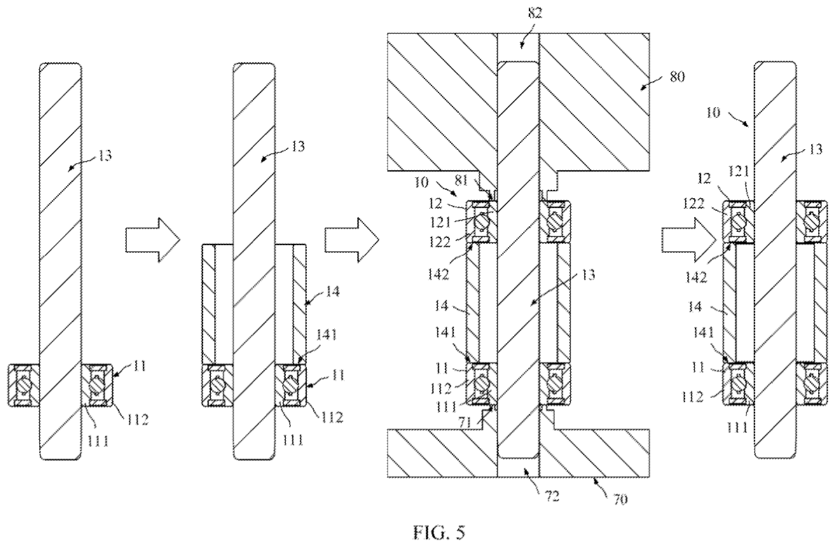

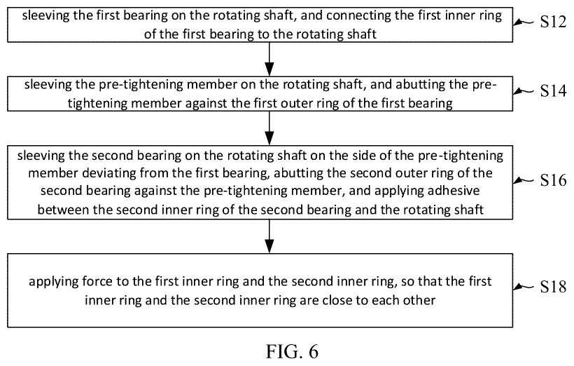

In a third aspect, referring to FIG. 5 and FIG. 6, embodiments of this application provides a pre-tightening method for the integrated bearing structure 10 in the scanning drive motor 110/mechanical LiDAR drive platform, including:

Step S12, sleeving the first bearing 11 on the rotating shaft 13, and connecting the first inner ring 111 of the first bearing 11 to the rotating shaft 13. The first inner ring 111 and the rotating shaft 13 can be fixedly connected by adhesive, interference fit, welding, etc. In an embodiment, the first inner ring 111 and the rotating shaft 13 are connected by adhesive, and the adhesive is allowed to cure before proceeding to the next step.

Step S14, sleeving the pre-tightening member 14 on the rotating shaft 13, and abutting the pre-tightening member 14 against the first outer ring 112 of the first bearing 11. The pre-tightening member 14 and the first outer ring 112 are abutted, without further connection steps. The pre-tightening member 14 and the first outer ring 112 can be mechanically connected.

Step S16, sleeving the second bearing 12 on the rotating shaft 13 on the side of the pre-tightening member 14 deviating from the first bearing 11, abutting the second outer ring 122 of the second bearing 12 against the pre-tightening member 14, and applying adhesive between the second inner ring 121 of the second bearing 12 and the rotating shaft 13, where the adhesive is not cured. The specific step of applying adhesive between the second inner ring 121 and the rotating shaft 13 can be: applying adhesive to the inner side of the second inner ring 121 before sleeving the second bearing 12 on the rotating shaft 13, or applying adhesive to the corresponding part of the rotating shaft 13 before sleeving the second bearing 12 on the rotating shaft 13. The second outer ring 122 and the pre-tightening member 14 are abutted, without further connection steps. Of course, the second outer ring 122 and the pre-tightening member 14 can also be mechanically connected. In this step, the adhesive is not cured to facilitate the next step.

Step S18, applying force to the first inner ring 111 and the second inner ring 121, so that the first inner ring 111 and the second inner ring 121 are close to each other. When the adhesive is cured, the pre-tightening of the first bearing 11 and the second bearing 12 in the integrated bearing structure 10 is implemented. In an embodiment, the position of the first inner ring 111 and the second inner ring 121 can be adjusted to achieve the pre-tightening of the first bearing 11 and the second bearing 12 before the adhesive cures, and the pre-tightened state is maintained after the adhesive cures, achieving pre-tightening adjustment and fixing the pre-tightened state through the adhesive connection of the second inner ring 121 to the rotating shaft 13.

In an embodiment, both the first inner ring 111 and the second inner ring 121 are connected to the rotating shaft 13 by adhesive. Adhesive connections can better ensure the rotational precision of the first bearing 11 and the second bearing 12 compared to interference fit connections.

In the above step S18, the implementation process of applying force to the first inner ring 111 and the second inner ring 121 to make them close to each other can be: setting a first jig 70 and a first weight 80 at the two ends of the first bearing 11 and the second bearing 12 that deviate from each other, and making the first abutting surface 71 of the first jig 70 abut against the first inner ring 111 of the first bearing 11, the second abutting surface 81 of the first weight 80 abut against the second inner ring 121 of the second bearing 12, and the two ends of the rotating shaft 13 are respectively set in the first limit hole 72 of the first jig 70 and the second limit hole 82 of the first weight 80, both extending in the vertical direction. Thus, under the gravity of the first jig 70 or the first weight 80, the first inner ring 111 and the second inner ring 121 will move close to each other.

The first abutting surface 71 of the first jig 70 can be perpendicular to the central axis of the first limit hole 72, and the second abutting surface 81 of the first weight 80 can be perpendicular to the central axis of the second limit hole 82, to apply vertical force to the first inner ring 111 and the second inner ring 121 without causing the first bearing 11 and the second bearing 12 to deviate. During production, the existing processing technology can achieve high verticality between the first abutting surface 71 of the first jig 70 and the central axis of the first limit hole 72, as well as between the second abutting surface 81 of the first weight 80 and the central axis of the second limit hole 82, meeting pre-tightening requirements.

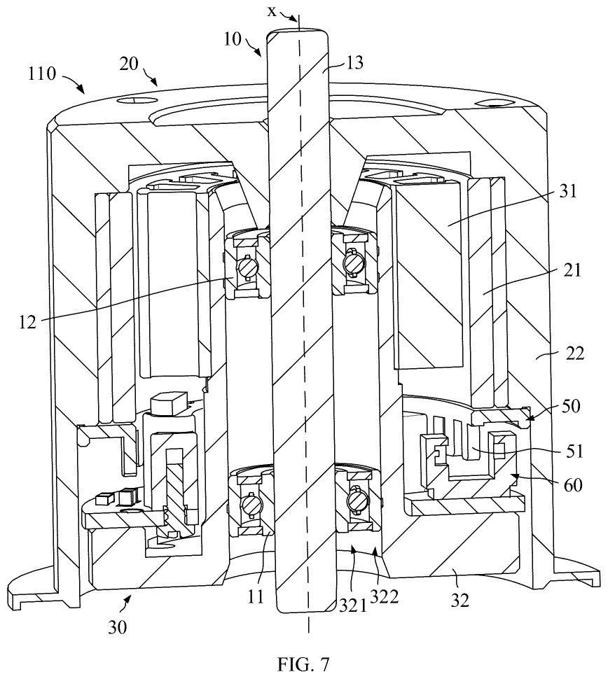

Referring to FIG. 7, embodiments of this application provides a scanning drive motor 110/mechanical LiDAR drive platform. The difference from the scanning drive motor 110/mechanical LiDAR drive platform shown in Embodiment 1 in FIG. 2 is that the integrated bearing structure 10 includes a first bearing 11, a second bearing 12, and a rotating shaft 13, but does not include a pre-tightening member 14. In an embodiment, by designing the first bearing 11, the second bearing 12, and the rotating shaft 13 as an integrated bearing structure 10, during assembly, the integrated bearing structure 10 can be assembled together with the mover assembly 20 and the stator assembly 30, making the assembly more convenient compared to the related technology where two bearings, the rotating shaft, the mover assembly, and the stator assembly are assembled separately.

The first inner wall surface 322 of the stator base 32 can be set as a cylindrical surface, allowing the corresponding space to be formed by processes such as stamping, achieving higher coaxiality of the first inner wall surface 322 along the length direction of the rotating shaft 13 (e.g., coaxiality within φ0.01 mm), thereby enhancing the rotational precision of the first bearing 11 and the second bearing 12 arranged corresponding to the first inner wall surface 322, and improving the detection precision of the LiDAR 1.

In an embodiment, to eliminate the clearance of the first bearing 11 and the second bearing 12, both the first outer ring 112 and the second outer ring 122 are connected to the first inner wall surface 322, implementing pre-tightening of the first bearing 11 and the second bearing 12.

During pre-tightening of the first bearing 11 and the second bearing 12, the first inner ring 111 of the first bearing 11 and the second inner ring 121 of the second bearing 12 can be fixedly connected to the rotating shaft 13, while the first outer ring 112 of the first bearing 11 and the second outer ring 122 of the second bearing 12 can be fixedly connected to the first inner wall surface 322. The first inner ring 111 and the rotating shaft 13, the second inner ring 121 and the rotating shaft 13, the first outer ring 112 and the first inner wall surface 322, and the second outer ring 122 and the first inner wall surface 322 can be fixedly connected by adhesive, interference fit, welding, etc.

In an embodiment, at least one of the first outer ring 112 and the second outer ring 122 is connected to the first inner wall surface 322 by adhesive. When the adhesive is not cured, the positions of the first outer ring 112 and the second outer ring 122 can be adjusted to achieve pre-tightening of the first bearing 11 and the second bearing 12, and the pre-tightened state is maintained after the adhesive cures.

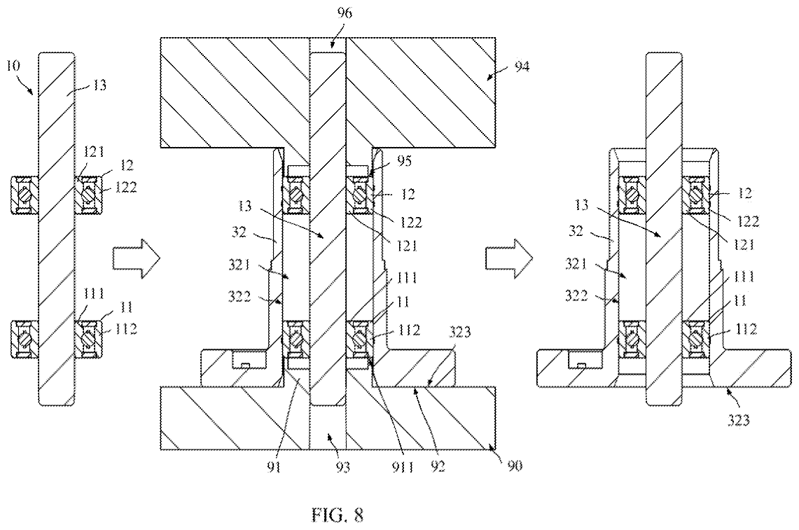

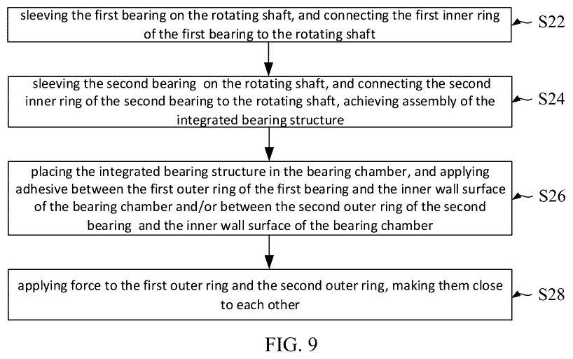

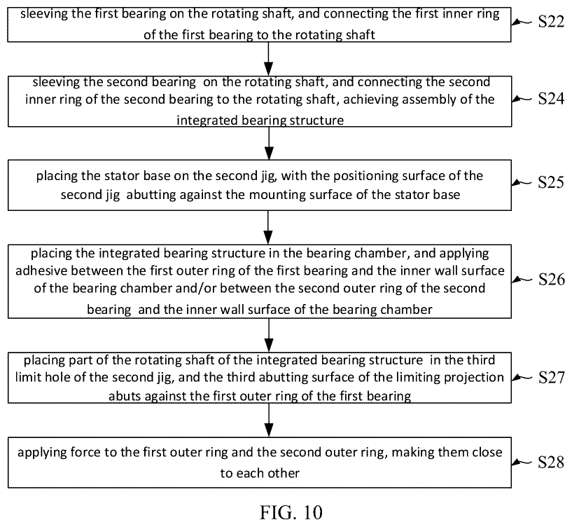

In an embodiment, referring to FIG. 8 to FIG. 10, the pre-tightening method for the integrated bearing structure 10 in the scanning drive motor 110/LiDAR includes:

Step S22, sleeving the first bearing 11 on the rotating shaft 13, and connecting the first inner ring 111 of the first bearing 11 to the rotating shaft 13. The first inner ring 111 and the rotating shaft 13 can be fixedly connected by adhesive, interference fit, welding, etc. In an embodiment, the first inner ring 111 and the rotating shaft 13 are connected by interference fit.

Step S24, sleeving the second bearing 12 on the rotating shaft 13, and connecting the second inner ring 121 of the second bearing 12 to the rotating shaft 13, achieving assembly of the integrated bearing structure 10. The second inner ring 121 and the rotating shaft 13 can be fixedly connected by adhesive, interference fit, welding, etc. In an embodiment, the second inner ring 121 and the rotating shaft 13 are connected by interference fit, ensuring the coaxiality of the first bearing 11 and the second bearing 12 through the rotating shaft 13.

Step S26, placing the integrated bearing structure 10 in the bearing chamber 321, and applying adhesive between the first outer ring 112 of the first bearing 11 and the inner wall surface of the bearing chamber 321 and/or between the second outer ring 122 of the second bearing 12 and the inner wall surface of the bearing chamber 321. In an embodiment, adhesive is applied between the first outer ring 112 and the inner wall surface of the bearing chamber 321 (e.g., the first inner wall surface 322) and between the second outer ring 122 and the inner wall surface of the bearing chamber 321 (e.g., the first inner wall surface 322), where the adhesive is not cured.

In an embodiment, if the first bearing 11 is located below the second bearing 12, adhesive can be applied to the inner wall surface of the bearing chamber 321 corresponding to the first bearing 11 before placing the integrated bearing structure 10 into the bearing chamber 321, and adhesive can be applied to the second outer ring 122 before placing the second bearing 12 on the rotating shaft 13, ensuring that the integrated bearing structure 10 can be placed into the bearing chamber 321 from top to bottom, achieving adhesive connections between the first outer ring 112 and the inner wall surface of the bearing chamber 321 and between the second outer ring 122 and the inner wall surface of the bearing chamber 321. Applying adhesive to the inner wall surface of the bearing chamber 321 corresponding to the first outer ring 112 before placing the integrated bearing structure 10 avoids scraping off a large amount of adhesive by the inner wall surface of the bearing chamber 321, ensuring stable connections between the first outer ring 112 and the inner wall surface of the bearing chamber 321. Applying adhesive to the second outer ring 122 before placing the integrated bearing structure 10 ensures that the first outer ring 112 does not take away the adhesive, ensuring stable connections between the second outer ring 122 and the inner wall surface of the bearing chamber 321.

Before placing the integrated bearing structure 10 in the bearing chamber 321, step S25 can be included, placing the stator base 32 on the second jig 90, and the limiting projection 91 of the second jig 90 extends into the bearing chamber 321 of the stator base 32, with the positioning surface 92 of the second jig 90 abutting against the mounting surface 323 of the stator base 32. The mounting surface 323 of the stator base 32 is perpendicular to the central axis of its bearing chamber 321. During production, the existing processing technology can achieve high perpendicularity between the mounting surface 323 of the stator base 32 and the central axis of its bearing chamber 321 (e.g., perpendicularity within (φ0.01 mm), meeting pre-tightening requirements.

After placing the integrated bearing structure 10 in the bearing chamber 321, step S27 can be included, placing part of the rotating shaft 13 of the integrated bearing structure 10 in the third limit hole 93 of the second jig 90, and the third abutting surface 911 of the limiting projection 91 abuts against the first outer ring 112 of the first bearing 11. The positioning surface 92 of the second jig 90 is perpendicular to the central axis of the third limit hole 93, ensuring that the rotating shaft 13 is perpendicular to the mounting surface 323 of the stator base 32. During production, the existing processing technology can achieve high perpendicularity between the positioning surface 92 of the second jig 90 and the central axis of the third limit hole 93, meeting usage requirements.

Step S28, applying force to the first outer ring 112 and the second outer ring 122, making them close to each other. When the adhesive cures, the pre-tightening of the first bearing 11 and the second bearing 12 is implemented. The implementation process of applying force to the first outer ring 112 and the second outer ring 122 can be: setting a second weight 94 on the side of the second bearing 12 deviating from the first bearing 11, and making the fourth abutting surface 95 of the second weight 94 abut against the second outer ring 122 of the second bearing 12. Part of the rotating shaft 13 is set in the fourth limit hole 96 of the second weight 94. Both the third limit hole 93 and the fourth limit hole 96 extend in the vertical direction. Under the gravity of the second weight 94, the first outer ring 112 and the second outer ring 122 move close to each other. The fourth abutting surface 95 of the second weight 94 can be perpendicular to the central axis of the fourth limit hole 96, ensuring even force on the first outer ring 112 and the second outer ring 122, avoiding deviation. During production, the existing processing technology can achieve high perpendicularity between the fourth abutting surface 95 of the second weight 94 and the central axis of the fourth limit hole 96, meeting usage requirements.

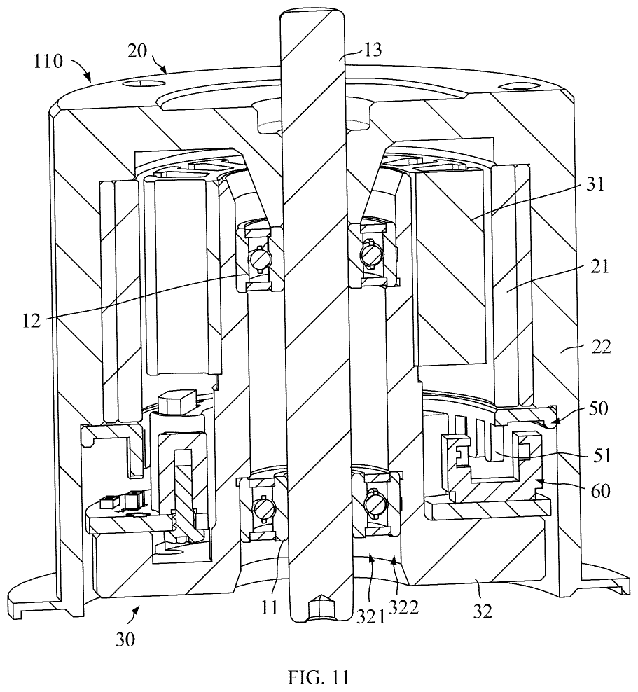

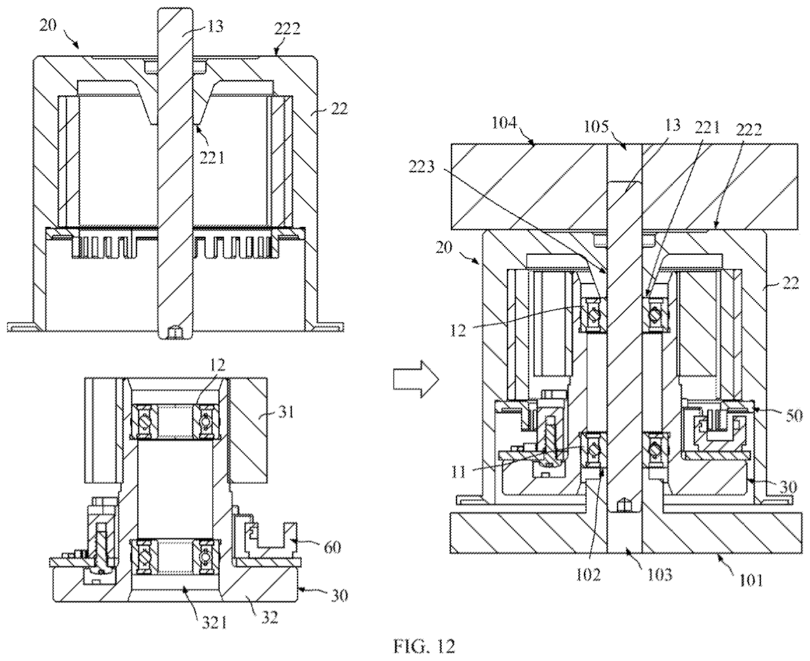

Referring to FIG. 11 and FIG. 12, embodiments of this application provides a scanning drive motor 110/mechanical LiDAR drive platform. The difference from the scanning drive motor 110/mechanical LiDAR drive platform shown in Embodiment 1 in FIG. 2 is that the first bearing 11, the second bearing 12, and the rotating shaft 13 are connected separately to the mover assembly 20 and the stator assembly 30, rather than designed as an integrated bearing structure 10 and connected together to the mover assembly and the stator assembly. The first bearing 11 and the second bearing 12 can be respectively connected to the stator assembly 30 as a structural part, and the rotating shaft 13 can be connected to the mover assembly 20 as another structural part, then the connected two structural parts can be connected together to achieve the connection of the first bearing 11, the second bearing 12, and the rotating shaft 13.

The first outer ring 112 of the first bearing 11 and the second outer ring 122 of the second bearing 12 can be connected to the inner wall surface of the bearing chamber 321 of the stator assembly 30 by adhesive, interference fit, welding, etc. In an embodiment, the first outer ring 112 and the second outer ring 122 are connected to the inner wall surface of the bearing chamber 321 of the stator assembly 30 by interference fit. The inner wall surface of the bearing chamber 321 can include a first step surface for positioning the installation position of the first bearing 11 and/or a second step surface for positioning the installation position of the second bearing 12.

At least one of the first inner ring 111 and the second inner ring 121 is connected to the rotating shaft 13 by adhesive. In an embodiment, both the first inner ring 111 and the second inner ring 121 are connected to the rotating shaft 13 by adhesive.

Referring to FIG. 12, before connecting the first inner ring 111 and the second inner ring 121 to the rotating shaft 13, adhesive is applied to the first inner ring 111 and the second inner ring 121, where the adhesive is not cured. When connecting the two structural parts, the rotating shaft 13 is inserted into the first inner ring 111 and the second inner ring 121 with a clearance fit. The stator assembly 30 can be placed on the third jig 101, and the first inner ring 111 of the first bearing 11 abuts against the fifth abutting surface 102 of the third jig 101. The sixth abutting surface 221 of the mover assembly 20 abuts against the second inner ring 121 of the second bearing 12, and a third weight 104 is set on the side surface 222 of the mover assembly 20 that deviates from the stator assembly 30. One end of the rotating shaft 13 extends into the fifth limit hole 103 of the third jig 101, and the other end extends into the seventh limit hole 223 of the mover assembly 20 and the sixth limit hole 105 of the third weight 104. Under the gravity of the third weight 104, the first inner ring 111 and the second inner ring 121 move close to each other, achieving pre-tightening of the first bearing 11 and the second bearing 12.

The sixth abutting surface 221 and the side surface 222 of the mover assembly 20 are perpendicular to the central axis of the seventh limit hole 223. The fifth abutting surface 102 of the third jig 101 is perpendicular to the central axis of the fifth limit hole 103. The connecting surface of the third weight 104 and the side surface 222 is perpendicular to the central axis of the sixth limit hole 105, ensuring even force on the first outer ring 112 and the second outer ring 122, avoiding deviation.

The fifth abutting surface 102 of the third jig 101 can be made of Teflon, ensuring that if adhesive inside the first bearing 11 and the second bearing 12 is brought out during assembly, it does not stick to the third jig 101.

As the adhesive inside the second inner ring 121 of the upper second bearing 12 is difficult to control during the insertion of the rotating shaft 13, the second inner ring 121 of the upper second bearing 12 may not be applied with adhesive, meaning the second inner ring 121 is not connected to the rotating shaft 13 by adhesive. Instead, the friction between the mover assembly 20 and the second inner ring 121 drives the second inner ring 121 to rotate.

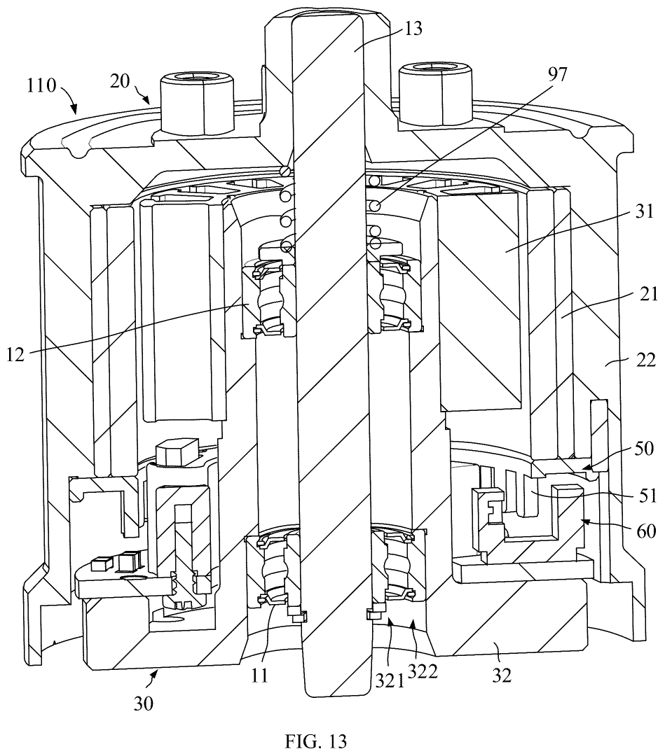

Referring to FIG. 13, the scanning drive motor 110/mechanical LiDAR drive platform in this embodiment differs from the scanning drive motor 110/mechanical LiDAR drive platform shown in Embodiment 1 in FIG. 2 in that the first bearing 11, second bearing 12, and rotating shaft 13 are connected separately to the mover assembly 20 and the stator assembly 30, rather than being designed as an integrated bearing structure 10 and connected together with the mover assembly and the stator assembly.

The first outer ring 112 of the first bearing 11 and the second outer ring 122 of the second bearing 12 can be connected to the inner wall surface of the bearing chamber 321 of the stator base 32 by adhesive, interference fit, welding, etc. The first inner ring 111 of the first bearing 11 and the rotating shaft 13 can also be connected by adhesive, interference fit, welding, etc.

In an embodiment, the first outer ring 112 and the second outer ring 122 are connected to the inner wall surface of the bearing chamber 321 by adhesive. The first inner ring 111 is connected to the rotating shaft 13 by adhesive. The second inner ring 121 is not connected to the rotating shaft 13 but is instead pre-tightened through a wave spring 97 that abuts against the mover assembly 20 (e.g., the housing 22), thereby achieving the pre-tightening of the first bearing 11 and the second bearing 12.

The terms “first,” “second,” etc., are used for descriptive purposes only and are not to be construed as indicating or implying relative importance. Unless otherwise specified, “multiple” means at least two, such as two, three, four, etc. “And/or” describes the relationship between associated objects, indicating that three relationships may exist, for example, A and/or B may mean: A alone, A and B together, or B alone. The character “/” generally indicates that the related objects are in an “or” relationship.

What is claimed is:

1. A scanning drive motor, comprising:
an integrated bearing structure, comprising a first bearing, a second bearing and a rotating shaft, the first bearing comprising a first inner ring and a first outer ring, the second bearing comprising a second inner ring and a second outer ring, the first bearing and the second bearing being sleeved on the rotating shaft, the first inner ring and the second inner ring being connected to the rotating shaft;
a mover assembly, comprising a mover; and
a stator assembly, comprising a stator and a stator base, the stator being connected to the stator base, the stator base being formed with a bearing chamber, the first bearing, the second bearing and at least a part of the rotating shaft being located in the bearing chamber, at least one of the first outer ring and the second outer ring being connected to the stator base, the rotating shaft being connected to the mover assembly, and the mover being capable of rotating relative to the stator around a central axis of the rotating shaft.

2. The scanning drive motor according to claim 1, wherein the stator base has a first inner wall surface participating in forming the bearing chamber, the first inner wall surface is in a form of a cylindrical surface wound around the rotating shaft and extending in a length direction of the rotating shaft, and the first bearing and the second bearing are both arranged corresponding to the first inner wall surface.

3. The scanning drive motor according to claim 1, wherein the integrated bearing structure further comprises:
a pre-tightening member, sleeved on the rotating shaft and located between the first bearing and the second bearing; and
the first outer ring and the second outer ring are both connected to the pre-tightening member, to implement pre-tightening of the first bearing and the second bearing.

4. The scanning drive motor according to claim 3, wherein the pre-tightening member has a first mating surface mating with the first outer ring and a second mating surface mating with the second outer ring, the first mating surface and the second mating surface are oppositely arranged along a length direction of the rotating shaft, the first mating surface and the second mating surface are both around the rotating shaft, and the first mating surface and the second mating surface are parallel.

5. The scanning drive motor according to claim 3, wherein at least one of the first inner ring and the second inner ring is connected to the rotating shaft via an adhesive, and the first outer ring, the second outer ring and the pre-tightening member are all abutted.

6. The scanning drive motor according to claim 1, wherein the stator base has a first inner wall surface participating in forming the bearing chamber, the first outer ring and the second outer ring are both connected to the first inner wall surface, to implement pre-tightening of the first bearing and the second bearing.

7. The scanning drive motor according to claim 6, wherein the first inner ring, the second inner ring and the rotating shaft are all connected by an interference fit, and at least one of the first outer ring and the second outer ring is connected to the first inner wall surface via an adhesive.

8. The scanning drive motor according to claim 1, further comprising:
a code disc, connected to one of the mover assembly and the stator assembly, the code disc comprising a plurality of detection portions, the plurality of detection portions being arranged at circumferential intervals around the rotating shaft; and
a photoelectric switch, connected to the other of the mover assembly and the stator assembly, wherein the plurality of detection portions of the code disc pass the photoelectric switch in turn when the mover rotates relative to the stator around the central axis of the rotating shaft.

9. A pre-tightening method for the integrated bearing structure in the scanning drive motor according to claim 3, comprising:
sleeving the first bearing on the rotating shaft, and connecting the first inner ring of the first bearing to the rotating shaft;
sleeving the pre-tightening member on the rotating shaft, and abutting the pre-tightening member against the first outer ring of the first bearing;
sleeving the second bearing on the rotating shaft and on a side of the pre-tightening member deviating from the first bearing, abutting the second outer ring of the second bearing against the pre-tightening member, and arranging an adhesive between the second inner ring of the second bearing and the rotating shaft, wherein the adhesive is not cured; and
applying a force to the first inner ring and the second inner ring, so that the first inner ring and the second inner ring are close to each other, and when the adhesive is cured, pre-tightening of the first bearing and the second bearing in the integrated bearing structure can be implemented.

10. The pre-tightening method according to claim 9, wherein the applying a force to the first inner ring and the second inner ring, so that the first inner ring and the second inner ring are close to each other comprises:
arranging a first jig and a first weight at two ends deviating from each other of the first bearing and the second bearing respectively;
making a first abutting surface of the first jig abut against the first inner ring of the first bearing;
making a second abutting surface of the first weight abut against the second inner ring of the second bearing; and
arranging the rotating shaft at two ends of the first jig and a second limit hole of the first weight;
wherein the first limit hole and the second limit hole extend along a vertical direction, a central axis of the first abutting surface of the first jig is perpendicular to a central axis of the first limit hole, and a central axis of the second abutting surface of the first weight is perpendicular to a central axis of the second limit hole.

11. A Light Detection and Ranging system (LiDAR), comprising:
an integrated bearing structure, comprising a first bearing, a second bearing and a rotating shaft, the first bearing comprising a first inner ring and a first outer ring, the second bearing comprising a second inner ring and a second outer ring, the first bearing and the second bearing being sleeved on the rotating shaft, the first inner ring and the second inner ring being connected to the rotating shaft;
a mover assembly, comprising a mover;
a stator assembly, comprising a stator and a stator base, the stator being connected to the stator base, the stator base being formed with a bearing chamber, the first bearing, the second bearing and at least a part of the rotating shaft being located in the bearing chamber, one of the first outer ring and the second outer ring being connected to the stator base, the rotating shaft being connected to the mover assembly, and the mover being capable of rotating relative to the stator around a central axis of the rotating shaft; and
a laser transceiving assembly, connected to the mover assembly.
